(19) United States
(12) Patent Application Publication
(10) Pub. No.: US 2011/0125348 A1
(43) Pub. Date: May 26, 2011

(54) Automatic Emergency Reporting

(76) Inventors: Gordon Robert Andrew Sandell, Bothell, WA (US); Stephen Y. Lee, Shoreline, WA (US); Bradley David Cornell, Lake Stevens, WA (US)

(21) Appl. No.: 12/623,909

(22) Filed: Nov. 23, 2009

(51) Int. Cl. G06F 19/00

(52) U.S. Cl. 701/14

(57) ABSTRACT

Technologies are described herein for providing automatic emergency reporting. The technologies are adapted to receive values of aircraft state parameters collected from one or more sensors arranged within an aircraft. The technologies then determine whether the collected values of the aircraft state parameters indicate normal or anomalous operation of the aircraft. Responsive to the determination of whether the aircraft state parameters indicate normal or anomalous operation of the aircraft, the technologies initiate an emergency reporting function. The emergency reporting function may transmit a report containing the collected values of the aircraft state parameters to a ground system via a data-link.

### BACKGROUND

Modern aircraft currently operated by the commercial airline industry may employ a suitable data acquisition system adapted to monitor flight information collected by a variety of sensors arranged through the aircraft. When collecting the flight information from the sensors, the data acquisition system may store the flight information in a physically-robust flight data recorder. This flight data recorder is commonly known as the aircraft's “black box.”

When an aircraft incident occurs and the aircraft is lost, incident responders may be faced with the difficult challenge of locating the aircraft. For example, incident responders may extrapolate existing air traffic control (“ATC”) location data to locate the aircraft. When the aircraft is located, the incident responders may begin the incident investigation by removing the flight data recorder from the aircraft. The incident responders may analyze the recorded flight information stored in the flight data recorder to determine the cause of the aircraft incident.

Prior to analyzing the recorded flight information stored in the flight data recorder, little may be known about the cause of the aircraft incident. However, incident responders on the ground may benefit from real-time flight information obtained prior to and during the occurrence of the aircraft incident. In particular, the real-time flight information can be utilized to locate the aircraft, as well as to aid in the incident investigation prior to and after the flight data recorder has been removed.

It is with respect to these considerations and others that the disclosure made herein is presented.

### SUMMARY

Technologies are described herein for providing automatic emergency reporting. According to embodiments, one or more sensors may be arranged within an aircraft in order to collect state data regarding the operation and/or condition of the aircraft. These sensors may include sensors existing on the aircraft and/or new sensors provided to obtain additional data. A state determination module may monitor at least a portion of the state data and determine whether the state data indicates that an aircraft incident is occurring or is about to occur. When the state determination determines that an aircraft incident is occurring or is about to occur based on at least a portion of the state data, the state determination module may initiate an emergency reporting function, whereby the state data is transmitted to a ground system. Upon receiving the state data, emergency personnel at the ground system can begin analyzing the state data in case of an aircraft incident or a possible aircraft incident.

According to one aspect presented herein, various technologies are provided for providing automatic emergency reporting. The technologies are adapted to receive values of aircraft state parameters collected from one or more sensors arranged within an aircraft. The technologies then determine whether the collected values of the aircraft state parameters indicate normal or anomalous operation of the aircraft. Responsive to that the determination of whether the collected values of the aircraft state parameters indicate normal or anomalous operation of the aircraft, the technologies initiate an emergency reporting function. The emergency reporting function may transmit a report containing the values of the aircraft state parameters to a ground system via a data-link.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing an illustrative aircraft communications architecture configured to provide automatic emergency reporting, in accordance with some embodiments;

FIG. 2 is a table showing an illustrative list of example aircraft state parameters, in accordance with some embodiments;

FIG. 3 is flow diagram illustrating aspects of an example method provided herein for providing automatic emergency reporting, in accordance with some embodiments; and

FIG. 4 is a computer architecture diagram showing aspects of an illustrative computer hardware architecture for a computing system capable of implementing aspects of the embodiments presented herein.

### DETAILED DESCRIPTION

The following detailed description is directed to technologies for providing automatic emergency reporting. According to some embodiments described herein, a state determination system may be adapted to collect values for a variety of aircraft state parameters from sensors arranged through the aircraft. The state determination system may determine whether one or more of the collected values of the aircraft state parameters indicate normal or anomalous operation of the aircraft. For example, the state determination system may compare the collected values of the aircraft state parameters to normal values of the aircraft state parameters. Normal values of the aircraft state parameters may include known values and/or parameter statuses of the sensors indicating acceptable operation of the aircraft.

When the state determination system determines that one or more of the collected values of the aircraft state parameters indicate anomalous operation of the aircraft, thereby indicating a potential emergency, the state determination system may initiate an emergency reporting function. During the emergency reporting function, the state determination system may transmit frequent, periodic reports describing the current state of the aircraft and the location of the aircraft to a ground system. The incident responders may utilize the reports to locate the aircraft, as well as to aid in the incident investigation prior to removing the flight data recorder from the aircraft.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

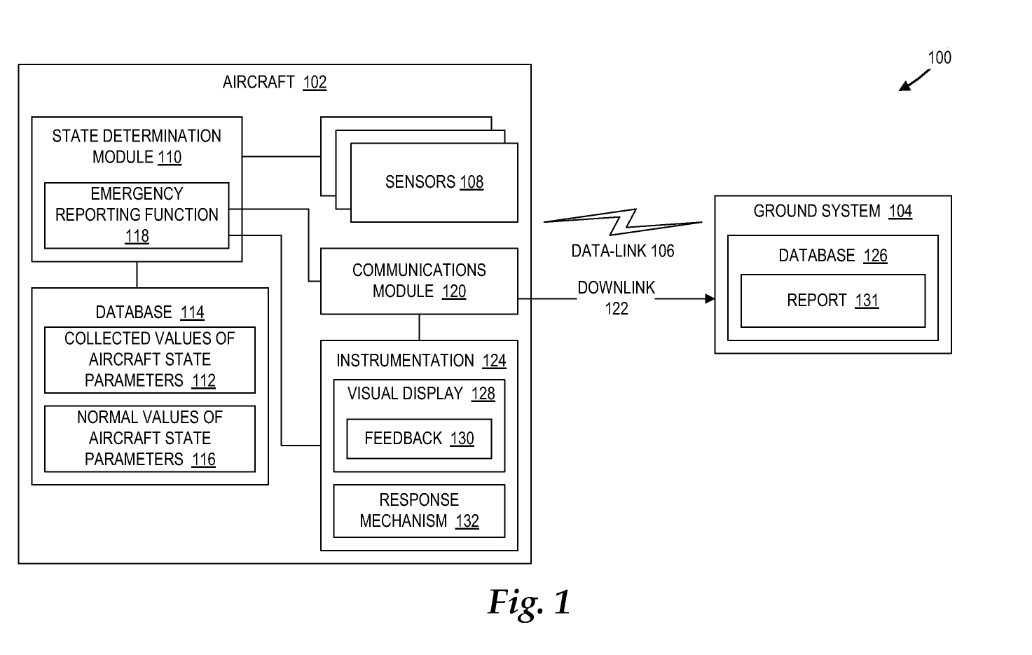

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for providing automatic emergency reporting will be described. FIG. 1 shows an illustrative aircraft communications architecture 100 configured to provide automatic emergency reporting, in accordance with some embodiments. The aircraft communications architecture 100 may include an aircraft 102 and a ground system 104. While the aircraft 102 is in flight, the aircraft 102 may communicate with the ground system 104 via a data-link 106. The data-link 106 may utilize radio, satellite, or other suitable communications means. In one embodiment, the data-link 106 may be provided by an Aircraft Communications Addressing and Reporting System (“ACARS”). The ground system (or ground facility) 104 may represent ATC, the manufacturer or the aircraft 102, the airline operating the aircraft 102, and/or the like.

The aircraft 102 may include one or more sensors 108 coupled to a state determination module 110. The sensors 108 may be arranged through the aircraft 102 in any suitable configuration. The sensors 108 may include any suitable transducers configured to collect various data about the state of the aircraft 102 while the aircraft 102 is in flight. This data about the state of the aircraft 102 may be referred to herein as aircraft state parameters. The aircraft state parameters may include, but are not limited to, the speed of the aircraft 102, the rate of descent of the aircraft 102, the altitude of the aircraft 102, the pitch angle of the aircraft 102, the bank angle of the aircraft 102, the pitch rate of the aircraft 102, the ATC beacon code, the amount of fuel on the aircraft 102, the position of the aircraft 102, and the cabin altitude of the aircraft 102. Additional examples of the aircraft state parameters may include landing gear status (e.g., up, down, locked, etc.), autopilot engage status, engine oil quantity, engine speed (e.g., N1, N2, and N3), engine pressure measurements such as engine pressure ratio (“EPR”) and total pressure ratio (“TPR”), oil temperature, oil pressure, air temperature, flap/slat position, anti-ice switch position, actual navigation performance, and wind speed and direction.

The state determination module 110 may collect values of the aircraft state parameters 112 from the sensors 108 and store the values of the aircraft state parameters 112 in a database 114. The state determination module 110 may collect the values of the aircraft state parameters 112 from the sensors 108 in real-time or near real-time. Further, the state determination module 110 may collect the values of the aircraft state parameters 112 from the sensors 108 at regular intervals or upon demand.

Upon collecting the values of the aircraft state parameters 112 from the sensors 108, the state determination module 110 determine whether the collected values of the aircraft state parameters 112 indicate normal or anomalous operation of the aircraft 102. For example, the state determination module 110 may compare the collected values of the aircraft state parameters 112 to normal values of the aircraft state parameters 116. The normal values of the aircraft state parameters 116 may include values and/or parameter statuses of the aircraft state parameters which indicate normal (i.e., acceptable) operation or condition of the aircraft 102. If one or more of the collected values of the aircraft state parameters 112 indicate normal operation of the aircraft 102, then the state determination module 110 may determine that the current operation or current condition of the aircraft 102 does not warrant transmitting an emergency report to the ground system 104. If one or more of the collected values of the aircraft state parameters 112 indicate anomalous operation of the aircraft 102, then the state determination module 110 may determine that the current operation or current condition of the aircraft 102 warrants transmitting an emergency report to the ground system 104.

The normal values of the aircraft state parameters 116 may include values and/or parameter statuses for a variety of parameters associated with the operation and/or condition of the aircraft 102. For example, certain parameters may indicate that the aircraft 102 is experiencing or about to experience an aircraft incident. Examples of these parameters may include an unusually high rate of descent, a multiple-engine-out condition, airspeed exceeding velocity maximum operating (“VMO”) or mach maximum operating (“MMO”) by a given threshold, airspeed below given threshold (i.e., possibly indicating that the aircraft 102 is stalled while in flight), an amount of remaining fuel below a given threshold, a cabin altitude above a given threshold, and the like.

In some embodiments, the normal values of the aircraft state parameters 116 may be adjusted by the flight crew on the aircraft 102 and/or the airline operating the aircraft 102. In some other embodiments, the normal values of the aircraft state parameters 116 may be fixed and may not be adjusted by the flight crew on the aircraft 102 and/or the airline operating the aircraft 102. In yet other embodiments, the flight crew on the aircraft 102 and/or the airline operating the aircraft 102 may also activate (i.e., able) and/or deactivate (i.e., disable) at least some of the comparisons made between the collected values of the aircraft state parameters 112 and the normal values of the aircraft state parameters 116. In this way, the flight crew on the aircraft 102 and/or the airline operating the aircraft 102 can select the aircraft state parameters that are utilized to identify anomalous operation of the aircraft 102. That is, not all of the values of the aircraft state parameters 112 collected from the sensors 108 need to be utilized in order to determine normal or anomalous operation of the aircraft 102. The state determination module 110 may compare the collected values of the aircraft state parameters 112 to the normal values of the aircraft state parameters 116 for a given instance, for multiple instances, and/or for a given period of time. The state determination module 110 may also compare the values of the aircraft state parameters 112 at regular intervals or upon demand.

The normal values of the aircraft state parameters 116 may include minimum threshold values, maximum threshold values, and/or ranges. With a minimum threshold value, if one or more of the collected values of the aircraft state parameters 112 are below the minimum threshold value, then the collected values of the aircraft state parameters 112 indicate anomalous operation of the aircraft 102. With a maximum threshold value, if one or more of the collected values of the aircraft state parameters 112 are above the maximum threshold value, then the collected values of the aircraft state parameters 112 indicate anomalous operation of the aircraft 102. Ranges may include acceptable ranges and anomalous ranges. With an acceptable range, if one or more of the collected values of the aircraft state parameters 112 are outside of the acceptable range, then the collected values of the aircraft state parameters 112 indicate anomalous operation of the aircraft 102. With an anomalous range, if one or more of the collected values of the aircraft state parameters 112 are within the acceptable range, then the collected values of the aircraft state parameters 112 indicate anomalous operation of the aircraft 102.

In further embodiments, the normal values of the aircraft state parameters 116 may provide a parameter status or state (e.g. valid/invalid, etc.) rather than a numerical value. In yet further embodiments, one or more thresholds and one or more parameter statuses may be combined using Boolean logic (e.g., logical AND, logical OR, etc.) when determining whether the condition or operation of the aircraft 102 is normal or anomalous. In particular, by combining two or more of the normal values of the aircraft state parameters 116 through the use of Boolean logic, simple as well as complex relationships between the normal values of the aircraft state parameters 116 can be defined and identified by the state determination module 110.

When one or more of the collected values of the aircraft state parameters 112 indicate normal operation of the aircraft 102, the state determination module 110 may continue monitoring the aircraft state parameters and collecting values of the aircraft state parameters. When one or more of the collected values of the aircraft state parameters 112 indicate anomalous operation of the aircraft 102, the state determination module 110 may initiate an emergency reporting function 118.

According to embodiments, the emergency reporting function 118 may cause a communications module 120 to begin transmitting a report 131 containing the collected values of the aircraft state parameters 112 to the ground system 104 on a downlink 122 through the data-link 106. The ground system 104 may store the report 131 in a database 126. The report 131 may contain a binary, ASCII, or other suitable representation of the collected values of the aircraft state parameters 112. In some embodiments, the report 131 may be embodied in a single ACARS block embodying the collected values of the aircraft state parameters 112. Each ACARS block may contain 220 characters. By limiting the report 131 to a single ACARS block, the communications module 120 may have a greater probability of successfully transmitting collected values of the aircraft state parameters 112. Further, by limiting the report 131 to a single ACARS block, the bandwidth on the data-link 106 utilized to transmit the report 131 can be minimized, thereby allowing other downlinks (not shown), such as those transmitting maintenance messages, for example, to be transmitted. In some other embodiments, the report 131 may be embodied in multiple ACARS blocks embodying the collected values of the aircraft state parameters 112.

The communications module 120 may continue to transmit new updates of the collected values of the aircraft state parameters 112 for a predetermined amount of time, until the collected values of the aircraft state parameters 112 indicate normal operation of the aircraft 102, or until the downlink 122 is terminated. The emergency reporting function 118 may be unexpectedly terminated if, for example, the aircraft 102 is damaged. The emergency reporting function 118 may also be manually terminated by the flight crew on the aircraft 102 or by the ground system 104.

The emergency reporting function 118 may also trigger additional communications with the ground system 104 through Automatic Dependent Surveillance-Contract (“ADS-C”), Controller Pilot Data Link Communications (“CPDLC”), and/or the like. In particular, if an ADS connection is available, the emergency reporting function 118 may initiate the ADS emergency mode. Further, if a CPDLC connection is available, the emergency reporting function 118 may transmit a distress signal (e.g., “MAYDAY”), as well as the position of the aircraft 102, through the CPDLC.

The aircraft 102 may include instrumentation 124 configured to provide various information to the flight crew. The instrumentation 124 may include an Auxiliary Outboard Display or other suitable dedicated data link display, an Engine Indicating and Crew Alerting System (“EICAS”) display, and/or the like. The instrumentation 124 may include a visual display 128 configured to provide feedback 130 with respect to the operations of the state determination module 110 and/or the communications module 120. In one example, the feedback 130 may include an indication that the emergency reporting function 118 has been initiated (e.g., the visual display 128 may show “DATALINK EMERGENCY INITIATED”). In another example, the feedback 130 may also include an indication that the emergency reporting function 118 has been automatically initiated by the state determination module 110 and/or an indication that the emergency reporting function 118 has been manually initiated by the flight crew of the aircraft 102. The indication that the emergency reporting function 118 has been manually initiated by the flight crew may be utilized to alert the flight crew in case, for example, the emergency reporting function 118 has been inadvertently initiated. In yet another example, the feedback 130 may also include indications for one or more of the values and/or parameter statuses in the normal values of the aircraft state parameters 116.

The instrumentation 124 may also include a response mechanism 132 whereby the flight crew can manually initiate communications with the ground system 104. In some embodiments, the response mechanism 132 may include mechanical devices, such as buttons, switches, and the like. In some other embodiments, the response mechanism 132 may be a graphical user interface (“GUI”) accessible through the visual display 128. The response mechanism 132 may enable the flight crew to manually initiate the emergency reporting function 118 by providing an instruction through the response mechanism 132. The response mechanism 132 may also enable the flight crew to manually terminate the emergency reporting function 118 by providing an instruction through the response mechanism 132. The instruction to terminate the emergency reporting function 118 may be provided whether the emergency reporting function 118 was manually initiated by the flight crew and/or automatically initiated by the state determination module 110. In some embodiments, the response mechanism 132 may be adapted from existing devices on the aircraft 102. For example, while existing buttons on the aircraft 102 may each perform certain tasks when individually depressed, the buttons may be adapted such that depressing combinations of two or more of the buttons may perform additional tasks, such as initiating and terminating the emergency reporting function 118.

When the emergency reporting function 118 is automatically initiated and/or automatically terminated by the state determination module 110, the downlink 122 may include messages indicating that the emergency reporting function 118 has been automatically initiated and/or automatically terminated. Further, when the emergency reporting function 118 is manually initiated and/or manually terminated by the flight crew, the downlink 122 may include additional messages indicating that the emergency reporting function 118 has been manually initiated and/or manually terminated. In some embodiments, the emergency reporting function 118 may also be terminated by the ground system 104 through an instruction from the ground system 104. The feedback 130 may further include indications that that the emergency reporting function 118 have been manually terminated by the flight crew, automatically terminated, or terminated by the ground system 104.

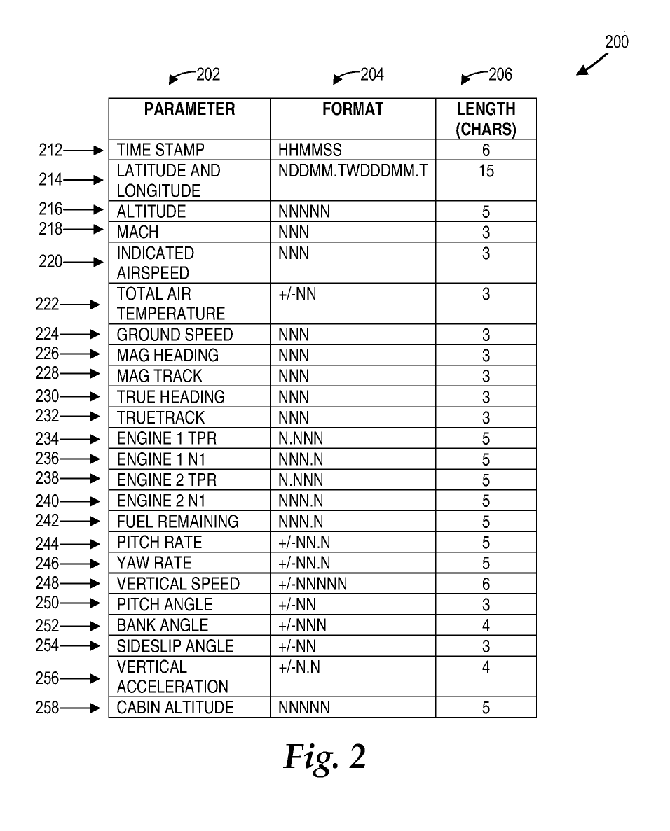

Referring now to FIG. 2, a table shows an illustrative list 200 of example aircraft state parameters, in accordance with some embodiments. In particular, when the state determination module 110 initiates the emergency reporting function 118, the emergency reporting function 118 may cause the communications module 120 to transmit the report 131 containing values of at least some of the aircraft state parameters to the ground system 104.

As illustrated in FIG. 2, the list 200 includes a first column 202, a second column 204, and a third column 206. The list 200 further includes a plurality of rows 212-258. Each of the rows 212-258 under the first column 202 shows one of the aircraft state parameters. Each of the rows 212-258 under the second column 204 shows a normal value of a corresponding one of the aircraft state parameters. Each of the rows 212-258 under the third column 206 shows the number of characters in an ACARS message utilized for the corresponding one of the normal values of aircraft state parameters 116. It should be appreciated that the content and format of the list 200 illustrated in FIG. 2 is merely an example is not intended to be limiting. Further, it should be appreciated that one skilled in the art will understand how to interpret the content and the format described in the list 200.

Examples of the aircraft state parameters are shown in the rows 212-258. The row 212 corresponds to a timestamp indicating when each of the values in the list 200 was received. Timestamps corresponding to one or more of the individual aircraft state parameters may also be contemplated. The format of the timestamp includes two characters representing hours, two characters representing minutes, and two characters representing seconds, although other time units may be similarly utilized. The row 214 corresponds to a latitude and longitude value. The format of the latitude and longitude value includes fifteen characters. The row 216 corresponds to an altitude value. The format of the altitude value includes five characters representing the altitude in feet, meters, or other suitable unit.

The row 218 corresponds to a mach number. The format of the mach number corresponds to three characters. The row 220 corresponds to an indicated airspeed. The format of the indicated airspeed includes three characters representing the indicated airspeed in miles per hour, kilometers per hour, or other suitable unit. The row 222 corresponds to total air temperature. The format of the total temperature includes one character representing a positive or negative temperature and two characters representing the temperature in Fahrenheit, Celsius, or other suitable unit.

The row 224 corresponds to a ground speed. The format of the ground speed includes three characters representing the ground speed in miles per hour, kilometers per hour, or other suitable unit. The row 226 corresponds to a magnetic (“mag”) heading value. The format of the mag heading value includes three characters representing the mag heading in degrees. The row 228 corresponds to a mag track value. The format of the mag track value includes three characters representing the mag track in degrees.

The row 230 corresponds to a true heading value. The format of the true heading value includes three characters representing the true heading in degrees. The row 232 corresponds to a true track value indicating a true North (rather than magnetic North). The rows 234 and 238 correspond to the engine 1 TPR value and the engine 2 TPR value. The rows 236 and 240 correspond to the engine 1 N1 value and the engine 2 N1 value.

The row 242 corresponds to the amount of fuel remaining. The format of the amount of fuel remaining includes five characters representing the amount of fuel remaining in gallons, liters, or other suitable unit, whereby one of the five characters is a decimal point. The row 244 corresponds to the pitch rate. The format of the pitch rate includes one character representing a positive or negative pitch rate and four characters, whereby one of the four characters is a decimal point. The row 246 corresponds to the yaw rate. The format of the yaw rate includes one character representing a positive or negative yaw rate and four characters, whereby one of the four characters is a decimal point.

The row 248 corresponds to a vertical speed. The format of the indicated airspeed includes one character representing a positive or negative vertical speed and five characters representing the vertical airspeed in miles per hour, kilometers per hour, or other suitable unit. The row 250 corresponds to a pitch angle. The format of the pitch angle includes one character representing a positive or negative pitch angle and two characters representing the pitch angle in degrees. The row 252 corresponds to a bank angle. The format of the bank angle includes one character representing a positive or negative bank angle and three characters representing the bank angle in degrees.

The row 254 corresponds to a sideslip angle. The format of the sideslip angle includes one character representing a positive or negative sideslip angle and two characters representing the sideslip angle in degrees. The row 256 corresponds to a vertical acceleration. The format of the vertical acceleration includes one character representing a positive or negative vertical acceleration and three characters representing the vertical acceleration in feet per second, meters per second, or other suitable unit, whereby one of the characters is a decimal point. The row 258 corresponds to a cabin altitude value. The format of the cabin altitude value includes five characters representing the cabin altitude in feet, meters, or other suitable unit.

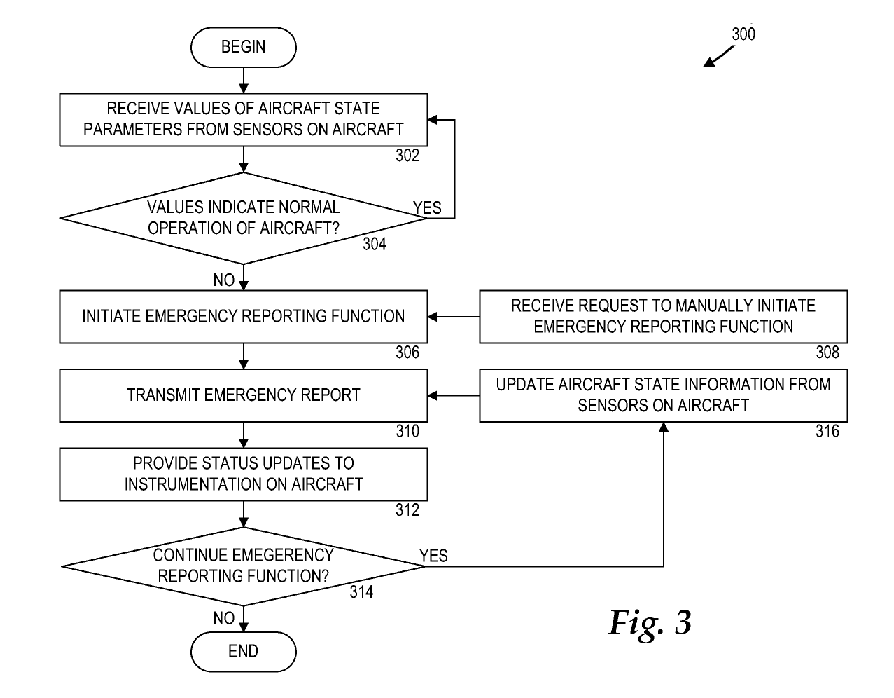

Referring now to FIG. 3, additional details will be provided regarding the operation of the state determination module 110. In particular, FIG. 3 is a flow diagram illustrating aspects of an example method provided herein for providing automatic emergency reporting, in accordance with some embodiments. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

As shown in FIG. 3, a method 300 begins at operation 302, where the state determination module 110 receives values of the aircraft state parameters 112 collected from the sensors 108. The aircraft state parameters may include the speed of the aircraft 102, the rate of descent of the aircraft 102, the altitude of the aircraft 102, the pitch angle of the aircraft 102, the bank angle of the aircraft 102, the pitch rate of the aircraft 102, the ATC beacon code, the amount of fuel on the aircraft 102, the position of the aircraft 102, the cabin altitude of the aircraft 102, and other suitable information about the operation and/or condition of the aircraft 102. Additional examples of the aircraft state parameters may include landing gear status (e.g., up, down, locked, etc.), autopilot engage status, engine oil quantity, air temperature, flap/slat position, anti-ice switch position, actual navigation position, and wind speed and direction. When the state determination module 110 receives the values of the aircraft state parameters 112 collected from the sensors 108, the method 300 proceeds to operation 304.

At operation 304, the state determination module 110 determines whether one or more of the values of the aircraft state parameters 112 indicate normal or anomalous operation of the aircraft 102. For example, the state determination module 110 may compare one or more of the collected values of the aircraft state parameters 112 to the normal values of aircraft state parameters 116. The normal values of aircraft state parameters 116 may include values and/or parameter statuses for a variety of parameters associated with the operation and/or condition of the aircraft 102. For example, certain parameters or combinations of parameters may indicate that the aircraft 102 is experiencing or about to experience an aircraft incident. By comparing the one or more of the collected values of the aircraft state parameters 112 to the normal values of the aircraft state parameters 116, the state determination module 110 can determine whether the collected values of the aircraft state parameters 112 indicate normal or anomalous operation of the aircraft 102. When one or more of the collected values of the aircraft state parameters 112 indicate normal operation of the aircraft 102, the state determination module 110 may determine that the operation or condition of the aircraft 102 is acceptable and does not warrant an emergency report. When one or more of the collected values of the aircraft state parameters 112 indicate anomalous operation of the aircraft 102, the state determination module 110 may determine that the operation or condition of the aircraft 102 warrants an emergency report.

If the state determination module 110 determines that the operation or condition of the aircraft 102 is acceptable and does not warrant an emergency report, then the method 300 returns to operation 302, where the state determination module 110 continues to monitor the aircraft state parameters and receive the values of the aircraft state parameters 112 collected from the sensors 108. If the state determination module 110 determines that the operation or condition of the aircraft 102 warrants an emergency report, then the method 300 proceeds to operation 306, where the state determination module 110 initiates the emergency reporting function 118. In further embodiments, the state determination module 110 also receives, at operation 308, a request to manually initiate the emergency reporting function 118. For example, the flight crew may manually initiate the emergency reporting function 118.

According to embodiments, the emergency reporting function 118 may cause the communications module 120 to begin transmitting, at operation 310, the collected values of the aircraft state parameters 112 to the ground system 104. In this way, the ground system 104 can be made aware of an aircraft incident or a potential of an aircraft incident on the aircraft 102. The collected values of the aircraft state parameters 112 may be formatted as a report, such as the report 131. The emergency reporting function 118 may also trigger additional communications with the ground system 104 through ADS, CPDLC, and/or the like. When the state determination module 110 initiates the emergency reporting function 118 and the communications module 120 transmits the collected values of the aircraft state parameters 112 to the ground system 104, the method 300 proceeds to operation 312.

At operation 312, the state determination module 110 provides status updates regarding the emergency reporting function 118 and/or the communications module 120 to the instrumentation 124. In particular, the instrumentation 124 may include the visual display 128 to provide the feedback 130 regarding the emergency reporting function 118 and/or the communications module 120. The instrumentation 124 may also include the response mechanism 132, with which the flight crew of the aircraft 102 can manually initiate the emergency reporting function 118 and/or manually terminate the emergency reporting function 118. When the state determination module 110 provides the status updates regarding the emergency reporting function 118 and/or the communications module 120 to the instrumentation 124, the method 300 proceeds to operation 314.

At operation 314, the state determination module 110 determines whether to continue monitoring the sensors 108 on the aircraft 102 and transmitting the collected values of the aircraft state parameters 112 to the ground system 104. In some implementations, the state determination module 110 continues to monitor the sensors 108 on the aircraft 102 without terminating, until a certain amount of amount of time passes, or while the collected values of the aircraft state parameters 112 indicate anomalous operation of the aircraft 102. In another implementation, the state determination module 110 continues to monitor the sensors 108 until the flight crew terminates the emergency reporting function 118. In yet another implementation, the state determination module 110 until personnel at the ground system 104 terminates the emergency reporting function 118.

When the emergency reporting function 118 is not terminated, the method 300 proceeds to operation 316, where the state determination module 110 updates the values of the aircraft state parameters 112 from the sensors 108. The method 300 then proceeds back to operation 310, where the updated values of the aircraft state parameters 112 are transmitted to the ground system 104. When the emergency reporting function 118 is terminated, the method 300 terminates.

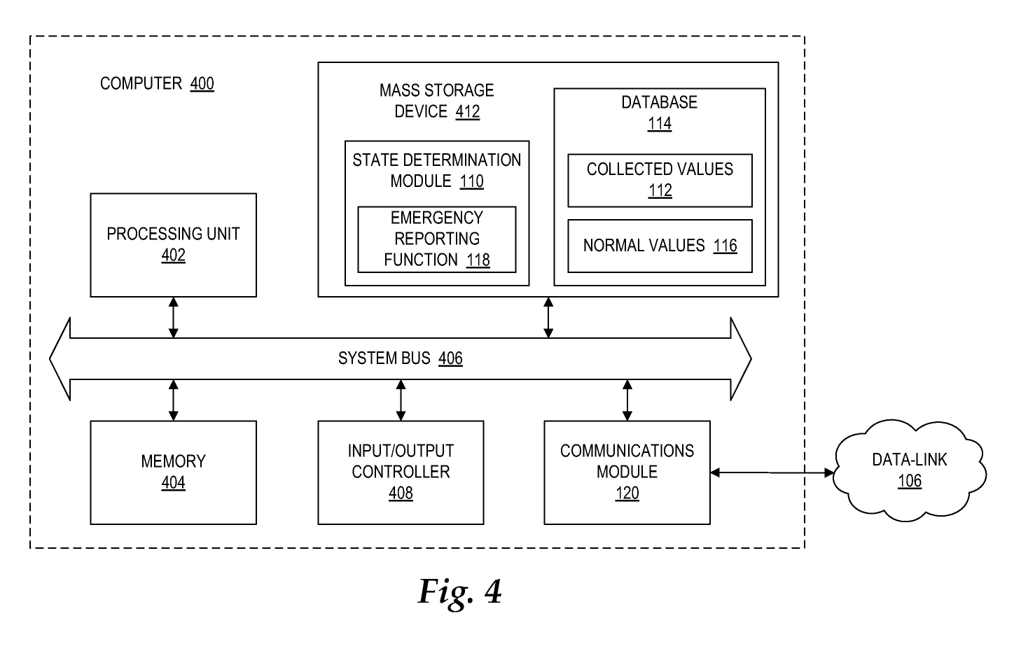

Referring now to FIG. 4, an exemplary computer architecture diagram showing aspects of a computer 400 is illustrated. The computer 400 may be configured to execute the state determination module 110. The computer 400 includes a processing unit 402 (“CPU”), a system memory 404, and a system bus 406 that couples the memory 404 to the CPU 402. The computer 400 further includes a mass storage device 412 for storing one or more program modules, such as the state determination module 110, and one or more databases, such as the database 114. The mass storage device 412 is connected to the CPU 402 through a mass storage controller (not shown) connected to the bus 406. The mass storage device 412 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available computer storage media that can be accessed by the computer 400.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network, such as the data-link 106. The computer 400 may connect to the network through a network interface unit, such as the communications module 120, connected to the bus 406. It should be appreciated that other types of network interface units may also be utilized to connect to other types of networks and remote computer systems. The computer 400 may also include an input/output controller 408 for receiving and processing input from a number of input devices (not shown), including a keyboard, a mouse or other suitable cursor control device, and a microphone. Similarly, the input/output controller 408 may provide output to a display or other type of output device (not shown) connected directly to the computer 400.

Based on the foregoing, it should be appreciated that technologies for providing automatic emergency reporting are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing automatic emergency reporting, the method comprising computer-implemented operations for:
receiving values of aircraft state parameters collected from one or more sensors arranged within an aircraft;
determining whether the collected values of the aircraft state parameters indicate normal or anomalous operation of the aircraft; and
responsive to the determination of whether the collected values of the aircraft state parameters indicate normal or anomalous operation of the aircraft, initiating an emergency reporting function, the emergency reporting function transmitting a report containing the collected values of the aircraft state parameters to a ground system via a data-link.

2. The computer-implemented method of claim 1, wherein determining whether the collected values of the aircraft state parameters indicate normal or anomalous operation of the aircraft comprises comparing the collected values of the aircraft state parameters to normal values of the aircraft state parameters; and wherein the normal values of the aircraft state parameters comprise numeric values or parameter statuses of one or more parameters.

3. The computer-implemented method of claim 1, the method comprising further computer-implemented operations for:
upon initiating the emergency reporting function, causing instrumentation on the aircraft to display an indication that the emergency reporting function has been initiated.

4. The computer-implemented method of claim 1, the method comprising further computer-implemented operations for:
receiving an instruction through instrumentation on the aircraft to initiate the emergency reporting function;
in response to receiving the instruction through the instrumentation to initiate the emergency reporting function, initiating the emergency reporting function; and
upon initiating the emergency reporting function, causing the instrumentation on the aircraft to display an indication that the emergency reporting function has been manually initiated.

5. The computer-implemented method of claim 1, the method comprising further computer-implemented operations for:
receiving an instruction through instrumentation on the aircraft to terminate the emergency reporting function;
in response to receiving the instruction through the instrumentation to terminate the emergency reporting function, terminating the emergency reporting function; and
upon terminating the emergency reporting function, causing the instrumentation on the aircraft to display an indication that the emergency reporting function has been manually terminated.

6. The computer-implemented method of claim 1, the method comprising further computer-implemented operations for:
receiving an instruction from the ground system to terminate the emergency reporting function;
in response to receiving the instruction from the ground system to terminate the emergency reporting function, terminating the emergency reporting function; and
upon terminating the emergency reporting function, causing instrumentation on the aircraft to display an indication that the emergency reporting function has been terminated by the ground system.

7. The computer-implemented method of claim 1, wherein the report embodiments the collected values of the aircraft state parameters in a single Aircraft Communications Addressing and Reporting System (“ACARS”) block transmitted via the data-link.

8. The computer-implemented method of claim 1, the method comprising further computer-implemented operations for:
upon initiating an emergency reporting function, initiating additional communications to the ground system through at least one of Automatic Dependent Surveillance-Contract (“ADS-C”) and Controller Pilot Data Link Communications (“CPDLC”).

9. A system for providing automatic emergency reporting, the system comprising:
a processor;
a memory coupled to the processor; and
a program module (i) which executes in the processor from the memory and (ii) which, when executed by the processor, causes the system to provide automatic emergency reporting by
receiving values of aircraft state parameters collected from one or more sensors arranged within an aircraft, the sensors collecting data regarding condition or operation of the aircraft,
determining whether the collected values of the aircraft state parameters indicate normal or anomalous operation of the aircraft by comparing the collected values of the aircraft state parameters to normal values of the aircraft state parameters, the normal values of the aircraft state parameters comprising numeric values and/or statuses of one or more parameters, and
responsive to the determination of whether the collected values of the aircraft state parameters indicate normal or anomalous operation of the aircraft, initiating an emergency reporting function, the emergency reporting function transmitting a report containing the collected values of the aircraft state parameters to a ground system via a data-link.

10. The system of claim 9, wherein aircraft comprises instrumentation, the instrumentation comprising a visual display and a response mechanism.

11. The system of claim 10, wherein the instrumentation comprises at least one of a dedicated data link display and an Engine Indicating and Crew Alerting System (“EICAS”) display.

12. The system of claim 10, wherein the program module, when executed by the processor, further causes the system to provide automatic emergency reporting by
upon initiating the emergency reporting function, causing the visual display to display an indication that the emergency reporting function has been initiated.

13. The system of claim 10, wherein the program module, when executed by the processor, further causes the system to provide automatic emergency reporting by
receiving an instruction through the response mechanism to initiate the emergency reporting function,
in response to receiving the instruction through the response mechanism to initiate the emergency reporting function, initiating the emergency reporting function, and
upon initiating the emergency reporting function, causing the visual display to display an indication that the emergency reporting function has been manually initiated.

14. The system of claim 10, wherein the program module, when executed by the processor, further causes the system to provide automatic emergency reporting by
receiving an instruction through the response mechanism to terminate the emergency reporting function;
in response to receiving the instruction through the response mechanism to terminate the emergency reporting function, terminating the emergency reporting function; and
upon terminating the emergency reporting function, causing the visual display to display an indication that the emergency reporting function has been manually terminated.

15. The system of claim 10, wherein the program module, when executed by the processor, further causes the system to provide automatic emergency reporting by
receiving an instruction from the ground system to terminate the emergency reporting function;
in response to receiving the instruction from the ground system to terminate the emergency reporting function, terminating the emergency reporting function; and
upon terminating the emergency reporting function, causing the visual display to display an indication that the emergency reporting function has been terminated by the ground system.

16. The system of claim 10, wherein the program module, when executed by the processor, further causes the system to provide automatic emergency reporting by
upon initiating the emergency reporting function, causing the visual display to display which of the aircraft state parameters indicate anomalous operation of the aircraft.

17. The system of claim 9, wherein the report embodiments the collected values of the aircraft state parameters in a single ACARS block transmitted via the data-link.

18. The system of claim 9, wherein the program module, when executed by the processor, further causes the system to provide automatic emergency reporting by
upon initiating an emergency reporting function, initiating additional communications to the ground system through at least one of ADS-C and CPDLC.

19. A computer-readable storage medium having computer-executable instructions stored thereon which, when executed by a computer, cause the computer to:
receive values of aircraft state parameters collected from one or more sensors arranged within an aircraft, the sensors collecting data regarding condition or operation of the aircraft;
determine whether the collected values of the aircraft state parameters indicate normal or anomalous operation of the aircraft by comparing the collected values of the aircraft state parameters to normal values of the aircraft state parameters, the normal values the aircraft state parameters comprising numeric values and/or statuses of one or more parameters;
responsive to the determination of whether the collected values of the aircraft state parameters indicate normal or anomalous operation of the aircraft, initiate an emergency reporting function, the emergency reporting function transmitting a report containing the collected values of the aircraft state parameters to a ground system via a data-link; and
upon initiating the emergency reporting function, cause a visual display in instrumentation on the aircraft to display an indication that the emergency reporting function has been initiated.

20. The computer-readable storage medium of claim 19, wherein the emergency reporting function terminates after a given period of time.
